(19) United States
(12) Patent Application Publication
(10) Pub. No.: US 2008/0225785 A1
(43) Pub. Date: Sep. 18, 2008

(54) RANDOM ACCESS RESOURCE MAPPING FOR LONG TERM EVOLUTION

(75) Inventors: Peter S. Wang, East Setauket, NY (US); Guodong Zhang, Farmingdale, NY (US); Jin Wang, Central Islip, NY (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/049,543

(22) Filed: Mar. 17, 2008

Related U.S. Application Data
(60) Provisional application No. 60/895,332, filed on Mar. 16, 2007.

(51) Int. Cl. H04Q 7/00

(52) U.S. Cl. 370/329

(57) ABSTRACT

A wireless transmit/receive unit (WTRU) receives a mapping of access service classes (ASCs) to its assigned access class. The ASC mapping may be based on message priority and logical channel priority. ASC mapping is directly or indirectly mapped to RACH preamble burst groupings and RACH signature groupings.

### CROSS REFERENCE TO RELATED APPLICATIONS

This application claims the benefit of U.S. provisional application No. 60/895,332 filed on Mar. 16, 2007, which is incorporated by reference as if fully set forth.

### FIELD OF INVENTION

The present invention is related to wireless communication systems.

### BACKGROUND

A number of processing methods have been proposed to map the higher layer wireless transmit/receive unit (WTRU) Access Classes (ACs) and Access Service Classes (ASCs) in long term evolution (LTE) 3GPP compliant networks. The ACs and ASCs can be mapped to physical layer non-synchronized random access channel (RACH) resources, preamble bursts and preamble signatures, that is, root Zadoff-Chu sequences and cyclic shifts. The goal is to provide prioritized service resources, in a physical layer, to various WTRU upper layer access class and access service class definitions for smooth RACH resource mapping operation.

The 3GPP standards group has initiated the LTE program to bring new technology, new network architecture, new configuration and new applications and services to wireless cellular networks in order to provide improved spectral efficiency and faster user experiences. Non-synchronized LTE Random Access physical layer resources include preamble bursts that are multiplexed with uplink data and control channels in frequency division multiplexing (FDM) and time division multiplexing (TDM). The resources also include preamble sequences in the code domain, where some initial access information bits are implicitly carried.

FIG. 1 shows a mapping of multiple random access channels according to the prior art. The random access channels RACH 1 and RACH 2 are defined to occupy a bandwidth BW_{RA}, typically set at 1.08 MHz (equivalent to 6 resource blocks), within the communication system bandwidth BW_{system} in the frequency domain. Preamble bursts (PBs) for RACH 1 and RACH 2 are shown having an access period TRA also equal to the transmission time interval (TTI), in order to provide sufficient number of random access opportunities. As shown in FIG. 1, each RACH preamble burst (PB) takes up all the bandwidth of the respective random access channel and lasts for a duration of one TTI.

A time period TRA-REP represents a number of TTIs that need to elapse before the next burst (TTI) can be used as a preamble for random access on the same random access channel.

Current LTE non-synchronized RACH preamble signatures use Zadoff-Chu sequences with Zero Correlation Zone (ZCZCZ) code word sequences generated from one or more root Zadoff-Chu sequences to achieve good detection probability in the uplink random access channel. For each configured RACH channel, there are 64 preamble signatures available.

An access class (AC) is used to identify groups of UEs and is assigned to the UE upon a connection request for the call. An access service class (ASC) is used in a random access procedure to define an access preamble signature and which access slot a UE should use. A wireless network defines an ASC for groups of UEs relating to access priority. For example, an ASC value may be an integer in the range of 0-7, where 0 may be used to indicate the highest priority granted by the network to users. Based on the prior art, WTRU AC mapping over ASC, and ASC mapping to LTE RACH physical resources, is not defined. It would be desirable to have several definitions and methods to fulfill the task of physical resource mapping from AC to ASC and from ASC to LTE RACH resources and methods to correlate the definitions to the prior art.

### SUMMARY

The present invention is related to a method and apparatus for mapping access class (AC) and RACH physical resources to access service class (ASC). The mapping is performed in a medium access control (MAC) layer.

### BRIEF DESCRIPTION OF THE DRAWINGS

A more detailed understanding may be had from the following description, given by way of example in conjunction with the accompanying drawings wherein:

FIG. 1 shows a prior art mapping for non-synchronized random access channels;

FIG. 2 shows a mapping of an equal number of random access preamble bursts in a preamble burst group allocation;

FIG. 3 shows a mapping of an unequal number of random access preamble bursts in a preamble burst group allocation;

FIG. 4 shows a mapping of an unequal number random access preamble burst groups within an extended burst time frame; and

FIG. 5 shows a block diagram of a receiver and transmitter implementation.

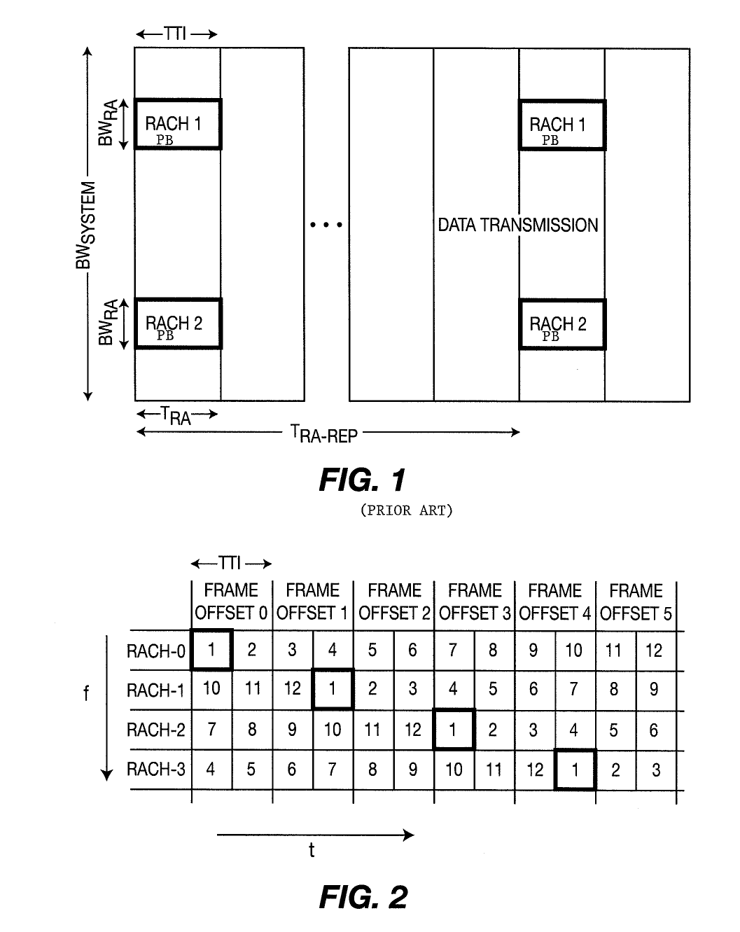

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The third generation partnership project (3GPP) has defined fifteen WTRU access classes (ACs) for different WTRU populations: ACs 0 to 15. ACs 0 to 9 are for WTRUs of ordinary users; ACs 11 to 15 are for WTRUs of maintenance crews; and there is no AC-10 currently defined.

In Universal Mobile Telecommunications Service (UMTS) Idle mode, the mapping for AC to ASC is performed in the medium access control (MAC) layer according to the system information broadcast. This gives the enhanced UMTS Radio Access Network (E-UTRAN) or network operator the flexibility of resource control based on the system load and traffic situation.

In a UMTS, each AC maps to a certain ASC number given by the “n^{th}” information element (IE) containing an ASC number 0-7, as shown in the chart below.

TABLE 1

| AC | 0-9 | 10 | 11 | 12 | 13 | 14 | 15 |
|---|---|---|---|---|---|---|---|
| ASC | 1^{st} IE | 2^{nd} IE | 3^{rd} IE | 4^{th} IE | 5^{th} IE | 6^{th} IE | 7^{th} IE |

Each IE contains an ASC number in the range of 0-7, and where ASC-0 takes the highest priority while ASC-7 has the lowest priority. Correcting for the undefined AC-10 results in the following mapping:

TABLE 2

| AC | 0-9 | 11 | 12 | 13 | 14 | 15 |
|---|---|---|---|---|---|---|
| ASC | 1^{st} IE | 2^{nd} IE | 3^{rd} IE | 4^{th} IE | 5^{th} IE | 6^{th} IE |

However, the above mapping restricts the mapping of AC0-AC9 mapping to one ASC and gives relatively greater flexibility to AC11-AC15. A more flexible AC to ASC mapping scheme is to allow AC0-AC9 to map to different ASCs and group ACs together if they map to the same ASC in terms of signaling. For example, from the above description, the following table presents an AC to ASC mapping applicable to the LTE_Idle state, where AC0-AC4 are grouped as a first ASC mapping, and AC5-AC9 are grouped as a second ASC mapping.

TABLE 3

| AC | 0-4 | 5-9 | 11 | 12-14 | 15 |
|---|---|---|---|---|---|
| ASC | 1^{st} IE | 2^{nd} IE | 3^{rd} IE | 4^{th} IE | 5^{th} IE |

In UMTS connected mode, ASC is selected according to the following condition for user plane logical channels:

ASC=min(NumASC,MinMLP); Equation (1)

where the parameter NumASC is the highest available ASC number and the parameter MinMLP is the highest priority level among the MAC logical channel priorities (MLP) (i.e., where the priority hierarchy is defined in order of lowest to highest values, with zero being the first priority). As can be seen from Equation (1), the logical channel priority is the determining parameter for ASC determination of user plane logical channels.

For a control plane logical channel, not all the control messages are of the same importance and priority. For example, the Radio Resource Control (RRC) Connection Request for an emergency call will have the highest priority, or an RRC Cell Update message, with a cause of radio link failure, will have a higher priority than an Initial Direct Transfer message carrying an NAS Tracking Area Update Request.

In a first embodiment, in order to allow priority of control plane messages to contribute to determination of ASC mapping, a “message priority” parameter is introduced as one of the parameters in determining the ASC priority in LTE_ACTIVE state, according to the following equation:

ASC=min(NumASC,min(MinMLP,message-priority)); Equation (2)

where the message-priority may be scaled to be on par with the ASC and MLP, for example in the range of 0-7. The benefit to this parameter is the handling of an urgent message with better LTE physical resource allocation. Another benefit is assisting the RRC to reduce the number of signaling radio bearers (SRBs). For example, in UMTS for RRC non-access stratum (NAS) messages, several signaling radio bearers are currently used: SRB-0 on CCCH plus SRB-1, SRB-2, SRB-3 and possibly an optional SRB-4 on DCCH. By using the message priority parameter, two SRBs could be assigned as one for RLC-UM mode and one for RLC-AM mode, eliminating the need for a third or fourth SRB. Alternatively, two SRBs could be assigned as one for RRC and one for NAS in RLC-AM mode if needed specifically when the UE is using RACH for uplink access. The message-priority term, for example ranging from 0 as highest priority to N for lowest priority, can be standardized or published in the system information. The message-priority term can be transmitted at start-up or assigned to a WTRU prior to start-up.

For high priority messages, a WTRU's RRC determines the type of message based on predetermined triggers. Examples of high priority messages and triggers include the following. For initial access during an emergency, a WTRU's RRC transmits a RRC-Connection-Request with an emergency indicator. A network entity, such as an eNodeB, assigns the WTRU to a high priority ASC accordingly. For a WTRU's handover access request, if using non-synchronized RACH access, the WTRU's RRC transmits a RRC-Connection Request having such indication and the eNB responds by assigning the WTRU to a high priority ASC. Other examples of high priority ASC mapping triggers include a RRC Connection Request for an uplink resource request access that includes out-of-sync recover access and for a cell update request (or LTE equivalent).

In another embodiment, ASC mapping considers RACH frequency hopping that is used for randomizing uplink interference, where more than one RACH is provided in a wireless network. Various forms of frequency hopping may be implemented, including the following. FIG. 2 shows a mapping for a round-robin hopping scheme for an example having four RACHs, RACH-0 to RACH-3, preamble bursts 1-12, and each time frame allowing two RACH accesses. Each preamble burst is assigned to one ASC, and each particular preamble burst is located in the next RACH in frequency domain as time progresses.

Referring to the preamble burst 1 highlighted in FIG. 2, preamble burst 1 rotates from RACH to RACH, beginning with RACH-0 in frame offset 0, next to RACH-1 in frame offset 1, RACH-2 for frame offset 3, and then RACH-3 for frame offset 4. Thus preamble-burst-1 has equal access chances with respect to both time and frequency channel. For example, if the preamble burst 1 is assigned to an ASC m value, it can be seen that for each of RACH-0, RACH-1, RACH-2 and RACH-3, the ASC m evenly rotates in time, which gives each RACH equal access with respect to preamble burst 1.

In general for the round robin hopping method, where there are K RACHs in the cell for uplink access, this method provides a particular burst, say burst-1, equally spaced time and frequency/channel opportunities to perform K random accesses to the network within the RACH access period.

Other alternative hopping patterns that may be used include, but are not limited to, an even/odd channel alternating pattern, a 1-to-N, N-to-1 sweeping pattern, and a random hopping pattern defined by specification. For example, given four RACH channels RACH-0, RACH-1, RACH-2 and RACH-3, an even/odd burst frequency pattern may be as follows: RACH-0, RACH-2, RACH-1, RACH-3, RACH-0, RACH-2, RACH-1, RACH-3, etc. An example of a 1-to-N, N-to-1 sweeping hopping pattern may be RACH-0, RACH-1, RACH-2, RACH-3, RACH-2, RACH-1, RACH-0, RACH-1, RACH-2, RACH-3, etc.

In another embodiment, for a given ASC and an allowed RACH access burst period, allocation and mapping of LTE network resources are performed either directly or indirectly. Such LTE resources include, but are not limited to preamble bursts, preamble signatures and power ramping parameters.

Methods for indirect mapping of LTE resources are described as follows. For preamble burst assignment mapping to ASC, a preamble-burst-group is defined as an abstract entity, but with concrete burst assignments. These preamble-burst-groups are allocated to individual ASCs to complete the ASC resource mapping. For example, to map to eight ASCs, R preamble-burst-groups can be defined, where R>=8, based on the priority of the ASC, so that one or more preamble-burst-groups can be allocated to the ASC. This provides design flexibility in the resource mapping so that the actual RACH resources (e.g., preamble bursts) can be mapped to the ASC with different possible combinations of the preamble-burst-groups. The network is therefore able to choose the resource allocations to ASCs, based on system or cell traffic conditions. There may be some resources that do not get assigned to particular ASCs.

There are at least two methods to map the RACH resource bursts to the access preamble-burst-group. One method is to map evenly with an equal number of RACH resource bursts to each preamble-burst-group. Another method is to map unequally with more bursts to the higher priority access preamble-burst-groups.

Referring to FIG. 2, a method is shown corresponding with the mapping of equal number of RACH resource bursts. Each of the four RACHs shown transmit at transmission time intervals (TTI) consisting of two time slots, (e.g., each time slot being 10 ms). Each preamble-burst-group may have an equal number of preamble bursts mapped to it. Each preamble-burst-group may employ preamble bursts with a hopping sequence over the next available RACH channel depending on the hopping scheme. This may help to mitigate uplink interference.

An example is given below. Given the following:

N_{RA}=4 (number of RACHs);

N_{burst-group}=12 (number of preamble-burst-groups);

N_{RA-REP}=5 (number of TTIs before next access on the same RACH); and

N_{max-burst-ramps}=4 (a factor related to max power ramping);

then for even preamble distribution, the number of time slots separating access for the same preamble burst group is according to the following:

$${N}_{slots} = \frac{{N}_{burst - group}}{{N}_{RA}} = \frac{12}{4} = 3 \qquad Equation ( 3 )$$

This is evident by observing highlighted preamble burst group-1, which reoccurs every third time slot. For 12 preamble burst groups, the number of time frames K_{RA} needed for a complete cycle is:

$${K}_{RA} = ( \begin{matrix}{N}_{burst - group} \times \\ {N}_{max - burst - ramps}\end{matrix} ) \times ( \frac{{N}_{RA - REP}}{{TTI}_{period}} ) \times \frac{1}{{N}_{RA}} \\ = ( 12 \times 4 ) \times ( \frac{5}{10} ) \times \frac{1}{4} = 6 \qquad Equation ( 4 )$$

where TTI_{period}=10 ms.

Each frame offset (TTI) includes two preamble bursts, shown as two blocks per RACH, with the assigned preamble burst group number from 1 to 12 shown in each burst block. Each preamble-burst-group 1 to 12 is mapped to an ASC. When mapping the ASC to a preamble burst group, the ASC priority may be achieved according to combinations of more than one preamble-burst-group's bursts. According to this method, the system defines more preamble-burst-groups than the ASCs (our example 8 ASCs, 12 preamble-burst-groups) such that the higher priority ASCs could be assigned with more preamble-groups, thus it has more chances for uplink access. As an example, ASC-0 can be assigned with 2 or more preamble-burst-groups while ASC-7 can be assigned with only one preamble-burst-group, as shown in Table-4 below. Thus ASC-0 would have twice as many chances to access the network via RACH. Note that the numbers of preambles for each preamble-burst-group should be the same, including a scenario where there is one preamble per preamble-group.

Alternatively, the preamble-burst-groups may be assigned an unequal number of preamble bursts according to the frequency hopping pattern selected. In such instances, the ACS mapping may give higher priority to preamble-burst-groups having more assigned preamble bursts, which gives more frequent access to RACHs.

Assignment of an ASC to the preamble burst groups may be performed using a bit mapping, as shown in Table 4. Each preamble-burst-group is represented as one bit in a bitmap of length R for (R=the number preamble burst groups). A position in the map can be represented by the preamble burst group number minus 1. For example, as shown in Table 4, ASC 0 is mapped to preamble burst group-1 and preamble burst group-9, as bit numbers 0 and 10 have a value equal to 1.

TABLE 4

| | RACH Access |
|---|---|
| | Preamble Burst Group |
| ASC | Bit map |
| 0 | 100000001000 |
| 1 | 010000000100 |
| 2 | 001000000010 |
| . | . |
| . | . |
| . | . |
| 6 | 000000100000 |
| 7 | 000000010000 |

One or more access preamble-burst-groups (represented by 1 bit) can be assigned to each ASC, depending on the priority and the traffic situations the system experiences.

As an alternative to indirect mapping of ASCs using preamble burst groups, ASCs can be directly assigned to RACH preamble bursts as now described. Each ASC may be mapped to an equal number of RACH preamble bursts, or by mapping higher priority ASCs to more preamble bursts than the lower priority ASCs. As an example of unequal ASC mapping, more RACH access preamble bursts are assigned to ASC-0 (highest priority) over an extended time period.

There may be a predetermined base number of preambles for each of the ASCs. Additional preambles N_{preamble-pri} may be determined by the number of RACH channels in cell N_{RA}, factored by an adjustment factor such as 2, as follows:

N_{preamble-pri}=N_{RA}×2 Equation (5)

Other adjustment factors, including 1.5, may be used. Table 5 shows an exemplary preamble assignment, where a base-number of preambles is augmented by additional integer values, with priority given to the highest priority ASC number, ASC-0, and lesser priority for the lower priority ASC numbers, ASC-1 to ASC-7. In this example, ASC-7 has only the base-number of preambles assigned to it.

TABLE 5

| ASC | | |
|---|---|---|
| number | Number of preambles assigned | Comment |
| 0 | Base-number preambles + 3 | Although this is the highest |
| | | ASC, there may not be many |
| | | emergency calls |
| 1 | Base-number preambles + 2 | Honor one other ASC with |
| | | easy access |
| 2 | Base-number preambles + 1 | One or more ASCs possess |
| | | the next priority |
| 3 | Base-number preambles + 1 | One or more ASCs possess |
| | | the next priority |
| 4 | Base-number preambles + 1 | — |
| . | . | . |
| . | . | . |
| . | . | . |
| 7 | Base-number preambles | — |

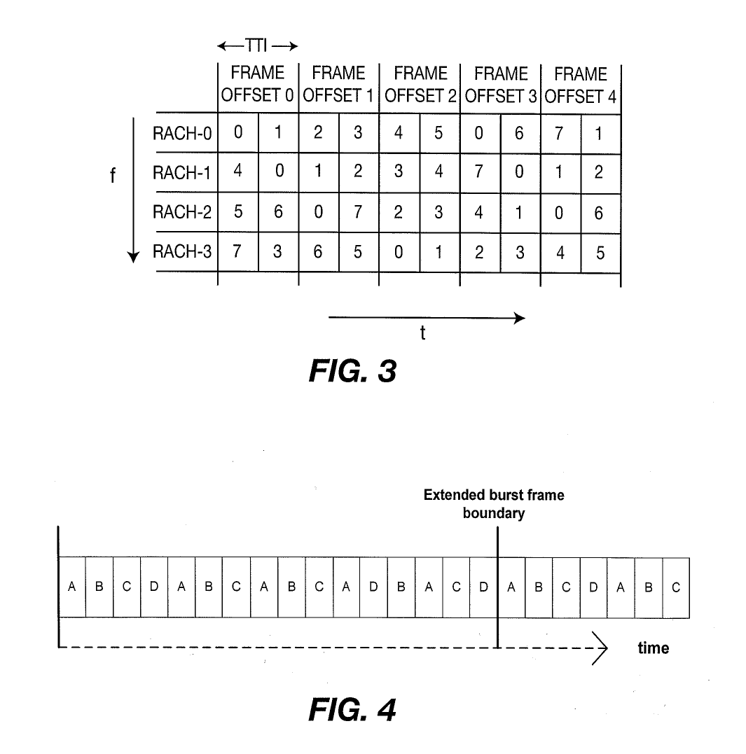

FIG. 3 shows a direct mapping of ACS, according to Table 5 mapping, for unequal number of preamble bursts, where the base number of preambles is four (4), and based on Equation (5), the total number of preambles N_{preamble-pri}=8. As shown in FIG. 3, the number of assigned preamble-bursts for ASC-0 is 7, which is derived by the base-number 4 plus 3 additional preambes (i.e., there are seven instances of ASC-0 appearing in the mapping of RACH-0 to RACH-3). The preamble-bursts are distributed for a particular ASC in time domain to minimize possible collisions. As shown in FIG. 3, the assignment for a particular ASC does not appear in same time period twice. All RACH accesses are taken into consideration as the system resource mapping via ACS is performed. For example, ACS mapping for RACH 0 depends on ACS mapping of RACH-1, RACH-2 and RACH-3 resources.

In another embodiment, RACH preamble signatures are taken into account for ASC mapping. There are typically 64 preamble signature sequence codes defined for each RACH channel. However, if there is high mobility in the network, the number of signatures may be reduced. Signature code assignments may also provide priority to a WTRU. A signature that is used by more than one WTRU in the same burst is considered by the system as having a collision in the uplink random access channel. Therefore, providing more preamble signatures to a specific ASC or equivalent would reduce the collision probability and increase the random access success rate.

Among the 64 preamble signatures of a RACH, an equal or unequal number of preamble signatures can be assigned to each signature-group such that one or more signature-groups can be allocated or mapped to one ASC. The network can use different combinations of signature-groups to allocate to various prioritized ASCs or non-prioritized ASCs depending on the cell traffic conditions.

For example, 10 signature groups can be allocated, with each signature group respectively having 10, 8, 8, 8, 6, 6, 6, 4, 4, 4 signatures. Each signature group may be represented by 1 bit in a 10-bit map (for bits 0 to 9), as shown in Table 6. Here, for example, signature group 1, is represented by bit 0, signature group 2 is represented by bit 1, and so on through bit 9. Signature-group combinations can be allocated to ASCs, prioritized or non-prioritized, as shown in Table 6 below.

TABLE 6
Indirect ASC mapping over Preamble bursts and signatures

| | RACH Access | RACH Access |
|---|---|---|
| ASC | Preamble Burst groups | Signature groups |
| 0 | 100000001000 | 1000000010 |
| 1 | 010000000100 | 0110000000 |
| 2 | 001000000010 | 0001100000 |
| . | . | . |
| . | . | . |
| . | . | . |
| 6 | 000000100000 | 0000000001 |
| 7 | 000000010000 | 0000000001 |

The network may map one signature-group to more than one ASC, as shown by ASC 6 and ASC 7 in Table 6. The ASCs share the preamble-signatures in a wide range. Indirect mapping of RACH preamble signatures to ASCs processes has advantages. The signatures may be assigned to ASCs with flexibility. The assignments may be adjusted based on traffic conditions. Signaling is improved over the “start/stop index” method, which is not able to handle a “broken sequence” situation.

Within an allocated signature-group, typically a number of signature codes are assigned to a particular ASC. WTRUs may, in addition to the use of channel quality index (CQI), use their specific identification codes as input seed to hash functions or other computation functions to make assignments more random. Alternatively, the WTRUs may employ a random number generator to select an index to increase the randomness of selecting one of the signatures within a group of signatures and for reducing the collision probability of different WTRUs selecting the same signature at the same time.

Since both preamble bursts and preamble signatures are configured per RACH, a WTRU should read the preamble signatures and the mappings of all the RACHs in a cell. This can be read from the system information, and when hopping from RACH to RACH, as the preamble signature assignment may be different. Therefore, it may be cumbersome to keep track of the assignment. As such, the following method is used for the case where no frequency hopping random access is provided.

Each WTRU may select a RACH from among a few offered from the serving cell, or, in the handover cases, a target cell RACH may be assigned by the handover command. A WTRU may select a RACH-n burst (time and frequency locations) in the serving cell using its international mobile subscriber identifier (IMSI), such that:

n=IMSI mod K Equation (6)

where K is the number of RACHs provided in the cell.

The same number of preamble bursts is assigned to all preamble-burst-groups to ACs in indirect mapping or to the ASCs in direct mapping. The preamble bursts appear in sequential order over time. Therefore, at the time of a burst of any group or ASC, the temporal distance to the next available burst of the same group or ASC is the same. As a result, burst assignments are not prioritized. Prioritized ASCs can still be realized through the use of preamble signature assignment.

In this method, more preamble bursts can be assigned to the preamble-burst-group or ASC with priorities than those with no priority without repeating the same assignment pattern over a period of time (e.g., many more LTE 10 ms frames minus an extended burst frame period).

FIG. 4 shows an example preamble burst assignment for a single RACH (i.e., no frequency hopping) to preamble-burst-groups A, B, C and D, such that for each extended burst frame, group A is assigned 5 bursts, groups B and C are assigned 4 bursts and group D is assigned 3 bursts. At the extended burst frame boundary, the pattern repeats. With an unequal number of bursts assigned to the preamble burst groups, priority treatment is provided to different preamble burst groups by the ASC mapping.

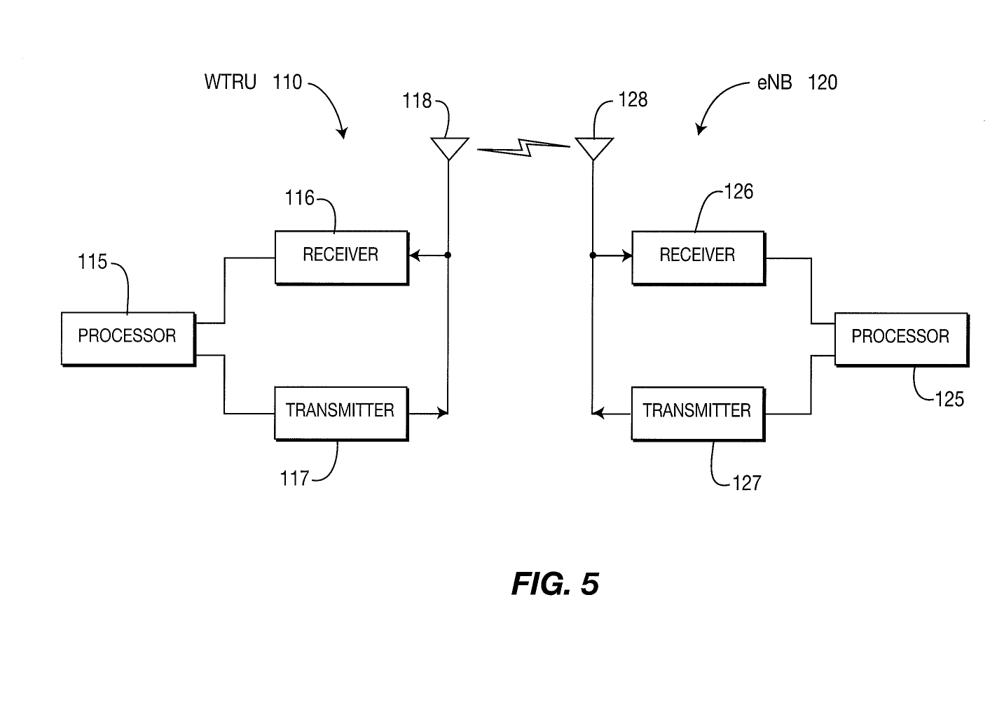

FIG. 5 is a functional block diagram of a WTRU 110, and an eNB 120 configured to perform the disclosed methods. In addition to components included in a typical transmitter/receiver, WTRU 110 includes a processor 115, receiver 116, transmitter 117 and antenna 118. The WTRU 110 is in wireless communication with eNB 120, comprising a processor 125, antenna 128, receiver 126 and transmitter 127. For example, with respect to the first embodiment method, the WTRU's processor 115 is configured to formulate the RRC connection request and to determine what type of message is being requested, such as an emergency message needing high priority on the RACH. The eNB processor 125 determines a message priority parameter and performs an ASC mapping of RACH using the message priority parameter. The eNB processor 125 determines RACH mapping according to the methods described above with respect to frequency hopping, direct or indirect ASC mapping, and RACH preamble signature mapping. The WTRU processor 115 is configured to transmit RACH preamble bursts according to the ASC mapping signaled by the eNB 120.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A wireless communication method implemented by an evolved Node B (eNB), comprising:
determining an access service class (ASC) mapping to an assigned access class (AC) for random access channel (RACH) communication, wherein the ASC mapping is according to available ASC numbers and a logical channel priority; and
transmitting the ASC mapping in a broadcast to a wireless transmit/receive unit (WTRU).

2. The method as in claim 1, further comprising:
receiving a radio resource control (RRC) connection request;
determining a message priority parameter based on the type of RRC connection request received from a wireless transmit/receive unit (WTRU), wherein the ASC mapping is based on the message priority parameter.

3. The method as in claim 1, further comprising assigning RACH preamble bursts to RACHs in an even-odd hopping pattern.

4. The method as in claim 1, further comprising allocating a plurality of preamble-burst-groups to each ASC.

5. The method as in claim 4, further comprising determining ASC mapping to a plurality of RACH resource preamble-burst-groups, where each of the preamble-burst-groups has an equal number of preamble bursts.

6. The method as in claim 4, further comprising performing ASC mapping to a plurality of RACH resource preamble-burst-groups, where there are an unequal number of preamble bursts to each preamble-burst group.

7. The method as in claim 4, further comprising representing each preamble-burst-group as one bit in a bitmap.

8. The method as in claim 1, further comprising performing ASC mapping to a signature code assignment.

9. The method as in claim 8, further comprising performing ASC mapping to a signature-group based on cell traffic.

10. A method for wireless communication implemented by a wireless transmit/receive unit (WTRU), comprising:
receiving an access service class (ASC) mapping to an assigned access class (AC) for random access channel (RACH) communication, wherein the ASC mapping is according to available ASC numbers and a logical channel priority; and
transmitting a burst on a RACH according to the received ASC mapping.

11. The method as in claim 10, further comprising:
transmitting a radio resource control (RRC) connection request for access on a RACH.

12. The method as in claim 10, further comprising transmitting RACH preamble bursts on a plurality of RACHs in an even-odd hopping pattern.

13. The method as in claim 10, further comprising receiving a preamble-burst-group assignment as part of the received ASC mapping.

14. The method as in claim 13, wherein the preamble-burst-group assignment is represented as one bit in a bitmap.

15. The method as in claim 10, further comprising receiving a signature code assignment as part of the received ASC mapping.

16. The method as in claim 10, further comprising selecting a RACH from a set of RACHs offered by a serving cell.

17. The method as in claim 10, further comprising selecting a RACH from a set of RACHs offered by a target cell.

18. An eNode B (eNB), comprising:
a processor configured to determine an access service class (ASC) mapping to an assigned access class (AC) for random access channel (RACH) communication, wherein the ASC mapping is according to available ASC numbers and a logical channel priority; and
a transmitter configured to transmit the ASC mapping in a broadcast to a wireless transmit/receive unit (WTRU).

19. The eNB as in claim 18, further comprising:
a receiver configured to receive a radio resource control (RRC) connection request from a WTRU;
wherein the processor is configured to determine a message priority parameter based on the type of RRC connection request received from the WTRU, and to determine the ASC mapping is based on the message priority parameter.

20. The eNB as in claim 18, wherein the processor is configured to assign RACH preamble bursts to RACHs in an even-odd hopping pattern.

21. The eNB as in claim 18, wherein the processor is configured to allocate a plurality of preamble-burst-groups to each ASC.

22. The eNB as in claim 21, wherein the processor is configured to determine ASC mapping to a plurality of RACH resource preamble-burst-groups, where each of the preamble-burst-groups has an equal number of preamble bursts.

23. The eNB as in claim 21, wherein the processor is configured to perform ASC mapping to a plurality of RACH resource preamble-burst-groups, where there are an unequal number of preamble bursts to each preamble-burst group.

24. The eNB as in claim 21, wherein the processor is configured to represent each preamble-burst-group as one bit in a bitmap.

25. The eNB as in claim 18, wherein the processor is configured to perform an ASC mapping to a signature code assignment.

26. The eNB as in claim 25, wherein the processor is configured to perform an ASC mapping to a signature-group based on cell traffic.

27. A wireless transmit/receive unit (WTRU), comprising:
a receiver configured to receive an access service class (ASC) mapping to an assigned access class (AC) for random access channel (RACH) communication, wherein the ASC mapping is according to available ASC numbers and a logical channel priority; and
a processor configured to select a RACH according to the received ASC mapping; and
a transmitter configured to transmit a burst on the selected RACH.

28. The WTRU as in claim 27, further comprising:
transmitting a radio resource control (RRC) connection request for access on a RACH.

29. The WTRU as in claim 27, wherein the transmitter is configured to transmit RACH preamble bursts on a plurality of RACHs in an even-odd hopping pattern.

30. The WTRU as in claim 27, wherein the processor is configured to select a RACH based on a received a preamble-burst-group assignment as part of the received ASC mapping.

31. The WTRU as in claim 30, wherein the preamble-burst-group assignment is represented as one bit in a bitmap.

32. The WTRU as in claim 27, wherein the processor is configured to select a RACH based on a received a signature code assignment as part of the received ASC mapping.

33. The WTRU as in claim 27, wherein the processor is configured to select a RACH from a set of RACHs offered by a serving cell.

34. The WTRU as in claim 27, wherein the processor is configured to select a RACH from a set of RACHs offered by a target cell.
